(19) United States
(12) Patent Application Publication
(10) Pub. No.: US 2005/0029456 A1
(43) Pub. Date: Feb. 10, 2005

(54) Sensor array with a number of types of optical sensors

(76) Inventors: Helmuth Eggers, Ulm (DE); Gerhard Kurz, Wendlingen (DE); Juergen Seekircher, Ostfildern (DE); Thomas Wohlgemuth, Aichtal (DE)

Correspondence Address: PENDORF & CUTLIFF, 5111 Memorial Highway, Tampa, FL, 33634-7356, US

(21) Appl. No.: 10/897,460

(22) Filed: Jul. 23, 2004

(30) Foreign Application Priority Data
Jul. 30, 2003 (DE) 103 35 190.6

(51) Int. Cl. G01J 5/02

(52) U.S. Cl. 250/339.02; 250/339.05

(57) ABSTRACT

Disclosed is a sensor array (3, 28) with a number of sensors (17, 18, 19, 20) arranged in periodic groups (21, 29, 30) for detection of electro-magnetic radiation, including sensors (17) of a first type for detection of radiation in an infrared spectral range and sensors (18, 19, 20) of at least a second type for detection of light in a visible spectral range. In each group (21, 29, 30) the number of sensors (17) of the first type exceeds the number of sensors (18, 19, 20) of the second type. Also disclosed is a camera (2) with such a sensor array (3, 28) as well as an image reproduction system (1) with such a camera (2) and a vehicle with such an image reproduction system (1).

### BACKGROUND OF THE INVENTION

1. Field of Invention

The invention concerns a sensor array with a number of sensors, arranged in periodic groups, for detection of electromagnetic radiation, including sensors of a first type for detection of radiation in an infrared spectral region and sensors of at least a second type for detection of light in a visible spectral region. The invention also concerns a camera with such a sensor array, as well as an image rendering system involving such a camera, and a vehicle with such an image rendering system. The inventive sensor array is suitable for employment in night vision devices, in particular vehicle night vision devices.

2. Related Art of the Invention

Currently, such night vision devices are being increasingly employed in motor vehicles in order to make it possible for the vehicle operator to maintain orientation in darkness and to facilitate recognition of objects. Night vision devices include sensors for detection of infrared radiation, also referred to as infrared sensors. Since this infrared radiation is thermal radiation, an image is produced in which differences in brightness correspond to the differential thermal distribution of the depicted objects. For this reason traffic signs and information displays appear in the images produced by night vision devices as surfaces with even light intensity, since these objects as a rule have a homogenous thermal distribution. Characters appearing on traffic signs and information boards thus cannot be displayed in recognizable manner on images produced by night vision devices. In order to overcome this problem, night vision devices are combined with color cameras which have sensors for detection of radiation in the visible spectral region and produce a color image. The image recorded by the infrared sensors is thus superimposed with the color image so that, in the combined image, color information of light-radiating objects is produced, whereby also writing on information boards appears in the combined image.

U.S. Pat. No. 6,150,930 discloses a sensor array with a number of sensors respectively of four different types, for detection of electromagnetic radiation. Among these sensors are sensors of a first type for detection of radiation in an infrared spectral region and sensors of second type for detection of light in a red wavelength range, sensors of third type for detection of light in a green wavelength range and sensors of a fourth type for detection of light in a blue wavelength range of the visible spectral region. In an image display system which is also described in U.S. Pat. No. 6,150,930, signals provided by the sensors of the first type produce an infrared image of a scene, and signals provided by the sensors of the second through the fourth type produce a color image of the same scene. Infrared image and color image are combined with each other to form a combined image of the scene, wherein the intensity of the infrared light of a pixel determines the luminosity or brightness of the pixels in the combined image. Accordingly, for each pixel of the image, at least one sensor of each of the four types respectively is necessary, thus at least four sensors per pixel. Thereby the problem occurs, that as the number of sensors necessary for display of a pixel increases, the space required on the sensor array for the pixel also increases.

### SUMMARY OF THE INVENTION

It is the task of the present invention to provide a sensor array with which images of a scene can be produced from combined infrared and color information, which makes possible a high local resolution with small dimensions of the sensor array.

This task is solved by a sensor array with the characterizing features of claim 1.

The subject matter of the invention also includes a camera with such a sensor array as well as an image reproduction system with such a camera and a vehicle with such an image reproduction system.

In the inventive sensor array the known effect is employed, whereby the human eye reacts approximately with ten times the sensitivity to changes in light intensity than to changes in color. That is, an observer does not detect any changes in quality between two images, of which in one the light intensity and color intensity both have high resolution, and a second, in which only the light intensity has a high resolution, and the chromatic resolution is significantly lower.

In conventional color video cameras, which work only in the visible spectral range, this effect cannot be used, since in order to determine the light intensity of each individual pixel of an image the light intensity of one of the pixels representing a point in the scene must be detected in three spectral ranges—red, green and blue—so that for each pixel three sensors corresponding to the spectral ranges must be provided.

When however the light intensity of the combined image to be produced depends only upon the infrared detected light intensity, then it is sufficient, when the sensor array detects the colors of a scene with a lower resolution than it detects light intensity in the infrared. As a consequence, by omitting unnecessary sensors for the visible spectral range, the comprehensiveness of the sensor array necessary for a given pixel count or number can be reduced or, as the case may be, with a specified dimension of the sensor array the resolution that can be achieved can be improved.

Particularly preferably, each group includes supplemental sensors of a third type and sensors of a fourth type, wherein the sensors of the second through fourth type detect visible light in respectively different wavelength ranges. With such a sensor array it becomes possible to represent for example colors of scene points according to the RGB-model, and, for example, the sensors of the second type detect light in a red wavelength range, the sensors of the third type detect light in a green wavelength range and the sensors of the fourth type detect light in a blue wavelength range.

Preferably, each group includes respectively one sensor of the second through fourth type. Of sensors of the first type there can, in each group, be present in particular three or 4n+1units, wherein n is a natural number.

A group with three sensors of the first type can represent for example three pixels of an image to be produced, wherein each pixel in the sensor array corresponds to the surface area of a sensor of the first type and the sensor of the second, third or fourth type. Color information obtained as the detection results of the sensors of the second through fourth type can be assigned to all three pixels of the group, while on the other hand the light intensity of all three pixels can be different.

The sensor array can be provided on a semiconductor substrate. In the opto-electronic transformer elements produced in the semiconductor substrate, all four types of sensors are preferably identical; the individual types differ essentially in the transmission characteristics of a filter, which covers over the semiconductor substrate.

If an image is recorded using a camera having the inventive sensor array, then a group corresponds to multiple pixels of the image. For example, each sensor of the first type can respectively represent one pixel. Then the light intensity with which a pixel appears in the image is established preferably by the detected light intensity values in the infrared range by the associated sensor of the first type, while the chromaticity of all pixels of the group is derived from the light intensity value of the respective sensors of the second through fourth type.

Alternatively, it is also possible for each individual sensor of the group to correspond to a pixel of the image. A pixel, which is assigned to the sensor of the first type, appears in the image, with the light intensity which is determined by the light intensity value detected by the associated sensor in the infrared. In a pixel assigned to a sensor of the second, third or fourth type the light intensity is determined by the light intensity value in the infrared detected by at least one adjacent sensor of the first type. The chromaticity of all pixels of the group is derived from the light intensity value in the visible spectral range detected by the pixels of the second through fourth types of the group.

An image reproduction system with a camera, which includes an inventive sensor array, preferably includes a display screen for displaying the image provided by the camera.

### Brief Description of the Drawings

In the following the invention will be described in greater detail on the basis of the figures.

Therein there is shown:

FIG. 1 an image reproduction system in simplified representation;

FIG. 2 a basic design of a section of an inventive sensor array;

FIG. 3 a cross-section through a section shown in FIG. 2;

FIG. 4 a basic design of a segment of a further inventive sensor array; and

FIG. 5 a group of a further inventive sensor arrays.

### Detailed Description of the Invention

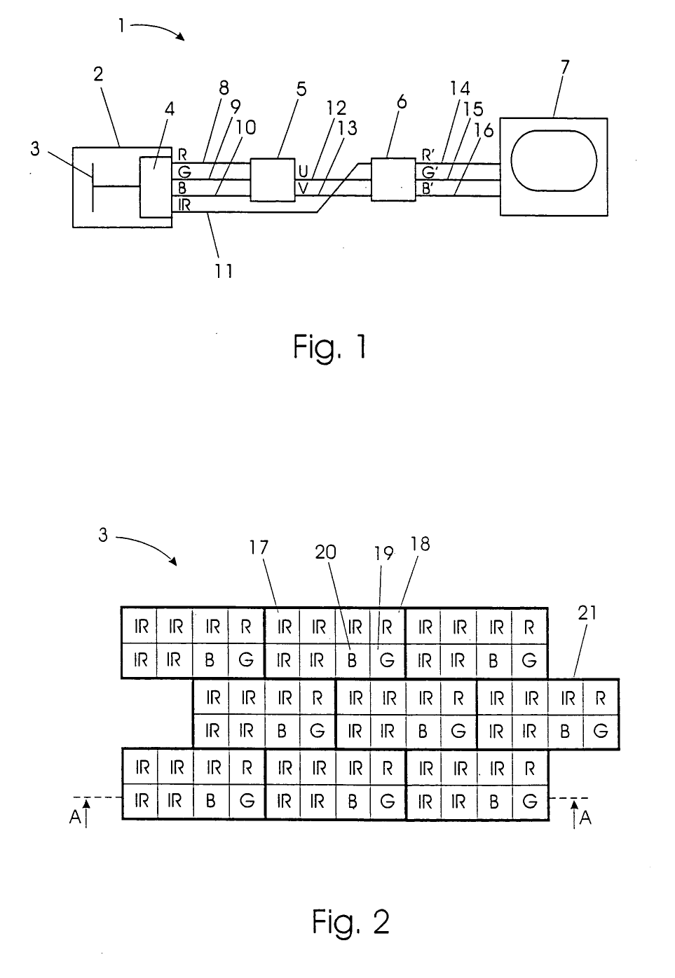

An inventive image reproduction system 1 is shown in simplified form in FIG. 1. The image reproduction system 1 includes a camera 2 with sensor array 3 and associated electronics 4, a first matrix 5, a second matrix 6 and a monitor 7. From the camera 2 an R-video channel 8, a G-video channel 9 and a B-video channel run to matrix 5. An IR-video channel 11 runs from the camera 2 to matrix 6. Further, a U-video channel 12 and a V-video channel 13 run from matrix 5 to matrix 6. From the matrix 6 an R′-video channel 14, a G′-video channel 15 and B′-video channel 16 run to monitor 7.

FIG. 2 shows a basic design of a segment of the sensor array 3. This includes IR-sensors 17 for detection of radiation in an infrared spectral range, R-sensors 18 for detection of light in a red wavelength range, G-sensors 19 for detection of light in a green wavelength range and B-sensors 20 for detection of light in a blue wavelength range. Respectively eight sensors 17, 18, 19, 20 form a group 21 wherein the group 21 includes five IR-sensors 17 and respectively one R-sensor 18, one G-sensor 19 and one B-sensor 20. Identical groups 21 are periodically arranged over a surface of the sensor array 3.

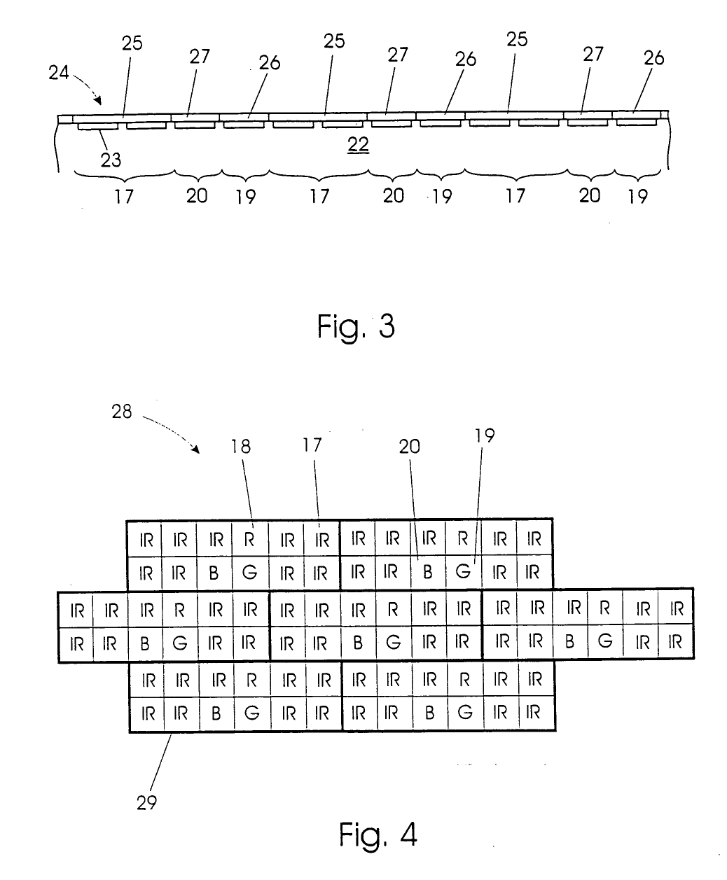

A cross-section through the sensor array 3 of FIG. 2, along dashed line A-A of FIG. 2, is shown in FIG. 3. All sensors 17, 18, 19, 20 include identically constructed opto-electronic transformer elements 23 on a substrate 22. A filter 24 covers the opto-electronic transformer elements 23. The filter 24 includes IR-transparent areas 25, which are transparent for electro-magnetic radiation in an infrared spectral range, G-transparent areas 26, which are transmissive for visible light in the green wavelength range and B-transparent areas 27, which are transparent for visible light in the blue wavelength range. Filter 24 further includes R-transparent areas, which are transmissive for visible light in the red wavelength range, which however are not visible in the representation according to FIG. 3. The transparent areas 25, 26, 27 are associated with one or more of the opto-electronic transformer elements 23.

The opto-electronic transformer elements 23 are sensitive for wavelength ranges on the basis of the selective transparency of the associated transparent areas 25, 26, 27 for respective various wavelength ranges of electro-magnetic radiation. Thus, the opto-electronic transformer elements 23, which are associated with an IR-transparent area 25, form the IR-sensors 11, transformer elements 23 which are associated with a G-transparent area 26 form the G-sensors 19, transformer elements 23 which are associate with a B-transparent area 27 form the B-sensors 20 and transformer elements 23 which are associated with R-transparent area form the R-sensors 18.

The image constructed of pixels which are recorded by the camera 2 can be reproduced on the monitor 7 using the image reproduction system 1. Therein each pixel of the image is represented by respectively one of the sensors 17, 18, 19, 20.

During recording, the IR-sensors 17 respectively provide one infrared intensity value, the IR-sensors 18 provide a red intensity value, the G-sensors 19 provide a green intensity value and the D-sensors 20 provide a blue intensity value, so that each pixel is originally assigned a light intensity value provided by the corresponding sensor 17, 18, 19, 20 representing it. The assignment electronics or circuitry 4 assigns within each group 21 to all of the pixels representing IR-sensors 17 of this group 21 the red light intensity value provided by the respective R-sensor 18, the green light intensity value provided by the respective G-sensor 19 and the blue light intensity value provided by the respective B-sensor 20. It assigns also to the pixel representing the R-sensor 18 the green light intensity value provided by the G-sensor 19 and the blue light intensity value provided by the B-sensor 20, to the G-sensor 19 representing pixel the red light intensity value provided by the R-sensor 18 and the blue light intensity value provided by B-sensor 20 and to the pixel representing the B-sensor 20 the red light intensity value provided by the R-sensor 18 and the green light intensity value provided by the G-sensor 19. Further, the pixels represented by the R-sensors 18, the pixels represented by the G-sensors 19 and the pixels represented by the B-sensors 20 are assigned a light intensity value provided by an adjacent IR-sensor 17. The organizing or regulating electronics or circuitry 4 insures that each pixel is associated with an infrared light intensity value, a red light intensity value, a green light intensity value and a blue light intensity value.

Alternatively to the described manner of assignment of the light intensity values, it is possible for example to derive an average infrared light intensity value from the five infrared light intensity values supplied by the five IR-sensors 17 and to assign this to the pixels representing the R-sensor 18, the G-sensor 19 and the B-sensor 20. It is also conceivable to assign infrared light intensity values to a pixel corresponding to an R-, G- or B-sensor which light intensity value is an average of the light intensity values which are provided by the IR-sensors 17 adjacent to the sensors 18, 19, 20 for these pixels, wherein these adjacent IR-sensors 17 may also belong to a different group than the concerned pixel.

The red, green and blue light intensity values of each pixel are provided from the camera 2 to the matrix 5 via the R-video channel 8, the G-video channel 9 and the B-video channel 10. The infrared light intensity values of each pixel are provided via the IR-video channel 11 from the camera 2 to the matrix 6.

The matrix 5 transforms the respective color defined by the red, green and blue light intensity values of each pixel into the known YUV-representation, in which a Y-signal specifies a light intensity and U-, V-signals specify the chromaticity of each pixel and provide the latter to the matrix 6 via the U-video channel 12 and the V-video channel 13.

The matrix 6 carries out the inverse transformation of the transformation for matrix 5, wherein the chromaticity signals U, V of matrix 5 are employed as U-, V-input signals and as light intensity input signals for the infrared light intensity values transmitted on IR-video channel 11, and produce for each pixel a new red, green and blue light intensity value. These new red, green and blue light intensity values of each pixel are relayed to the monitor 7 over the R′-video channel 14, the G′-video channel 15 and the B′-video channel 16, which monitor presents the pixel with these new light intensity values. Therewith a continuous color image is produced in which the light intensity of each pixel is determined by the infrared light intensity value, the chromaticity however remains the same, as is seen by the human eye. This makes it particularly simple for the observer to recognize objects in the combined image.

The invention is not limited to the sensor array 3 shown in FIG. 2. Thus FIG. 4 shows a further inventive sensor array 28 arranged in periodic groups 29. Each group 29 includes nine IR-sensors 17 and respectively one R-sensor 18, one G-sensor 19 and onw B-sensor 20. The sensor array 28 exhibits overall a still greater culling out of the sensors 18, 19, 20 than sensor array 3.

The groups 29 can represent one pixel per sensor 17, 18, 19, 20, thus a total of twelve pixels. In between two groups of four IR-sensors 17, which IR-sensors are respectively located at the corners of a quadrant, there are located respectively one IR-sensor 17 as well as one R-sensor 18, one G-sensor 19 and one B-sensor 20, which sensors are likewise located at the corners of a quadrant. Then, from the assignment or allocation electronic 4 of a camera 2 equipped with such a sensor array 28, nine pixels represented by the nine IR-sensors 17 are assigned one of the infrared light intensity values provided by the respective IR-sensor 17. These are likewise assigned or associated with red, green and blue light intensity values provided by the sensors 18, 19, 20. The pixels represented by the center sensors 18, 19, 20 obtain the light intensity values respectively provided by these three sensors 18, 19, 20. Further, from the nine infrared light intensity values supplied by the nine IR-sensors 17, an average infrared light intensity value is formed, which is assigned to the three pixels represented by the three sensors 18, 19, 20.

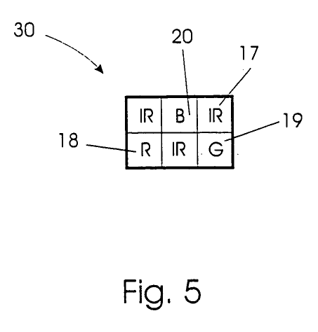

Finally, FIG. 5 shows a group 30 of a further sensor array according to the invention. The group 30 includes three IR-sensors 17 as well as respectively one R-sensor 18, G-sensor 19 and B-sensor 20. They represent three pixels, which respectively correspond to one IR-sensor 17 and one of the sensors 18, 19, 20. In the assignment electronics or circuitry 4 each pixel is assigned the two light intensity values provided by its own sensors 17 and 18, 19 or 20, that is, an infrared light intensity value as well as, depending upon sensor 18, 19, 20, a red or a green or a blue light intensity value as well as the light intensity value obtained in the two other pixels—red, blue or green. Therewith also with a camera having a sensor arrangement with these groups 30, each pixel is represented by an infrared light intensity value and a red, green and blue light intensity value, wherein however the local resolution of the camera 2 in the infrared is three times as high as that in the visible spectral range.

1. A sensor array (3, 28) with a number of sensors (17, 18, 19, 20) arranged in periodic groups (21, 29, 30) for detection of electro-magnetic radiation, including sensors (17) of a first type for detection of radiation in an infrared spectral range and sensors (18, 19, 20) of at least a second type for detection of light in a visible spectral range, wherein in each group (21, 29, 30) the number of sensors (17) of the first type exceeds the number of sensors (18, 19, 20) of the second type.

2. A sensor array (3, 28) according to claim 1, wherein each group (21, 29, 30) additionally includes sensors (18, 19, 20) of a third type and sensors (18, 19, 20) of fourth type, wherein the sensors (18, 19, 20) of the second through fourth type detect visible light in respectively differing wavelength ranges.

3. A sensor array (3, 28) according to claim 2, wherein the sensors (18) of the second type detect light in a red wavelength range, the sensors (19) of the third type detect light in a green wavelength range and the sensors (20) of the fourth type detect light in a blue wavelength range.

4. A sensor array (3, 28) according to claim 1, wherein each group (21, 29, 30) respectively includes one sensor (18, 19, 20) of the second through fourth type.

5. A sensor array (3, 28) according to claim 4, wherein one group (30) includes three sensors of the first type and respectively one sensor of the second through fourth type.

6. A sensor array (3, 28) according to claim 4, wherein one group (21, 29) includes 4n+1 sensors of the first type with n=1, 2, . . . , and respectively one sensor of the second through fourth type.

7. A sensor array (3, 28) according to claim 1, wherein it is provided upon a semi-conductor substrate (22).

8. A sensor array (3, 28) according to claim 7, wherein sensors (17, 18, 19, 20) of all types are identical light-sensitive opto-electronic transformer elements (23), and the sensor array (3, 28) includes a filter (24) with respectively different spectral transmissions according to the type of the sensor (17, 18, 19, 20).

9. A camera (2) with a sensor array (3, 28) according to one of the preceding claims, for providing a combined image, in which the light intensity of each pixel of the image is determined by at least one light intensity value in the infrared detected by a sensor (17) of the first type.

10. A camera (2) according to claim 9, wherein respectively one group (21, 29, 30) represents multiple pixels of an image.

11. A camera (2) according to claim 10, wherein each group (21, 29, 30) represents as many pixels, as there are included sensors (17) of the first type, that the light intensity of each pixel is determined by the light intensity value in the infrared detected by precisely one of the pixel associated sensors (17) of the first type, and that the chromaticity of each pixel is derived from the light intensity value derived from sensors (18, 19, 20) of the second through fourth types of the group (21, 29, 30).

12. A camera (2) according to claim 10, wherein each group (21, 29, 30) represents as many pixels as there are included sensors (17, 18, 19, 20) of the first through fourth type, that the light intensity of each of the sensors (17) of the first type is determined by the light intensity value detected by the sensor (17) of the first type, that the light intensity of each one sensor (18, 19, 20) of the second through fourth type associated pixels is determined by the light intensity value in the infrared range detected by a sensor (17) of the first type adjacent to one of these sensors (18, 19, 20), and that the chromaticity of each pixel is derived from the light intensity values derived from the sensors (18, 19, 20) of the second through fourth types of the group (21, 29, 30).

13. An image reproduction system (1) with a camera (2) according to claim 9, wherein it includes a display screen (7) for displaying the image provided by the camera (2).

14. A vehicle with an image reproduction system according to claim 13.
